(19) United States
(12) Patent Application Publication
(10) Pub. No.: US 2013/0293408 A1
(43) Pub. Date: Nov. 7, 2013

(54) RADAR IMAGE PROCESSING

(71) Applicants: James Patrick Underwood, Alexandria (AU); Giulio Reina, Bari (IT)

(72) Inventors: James Patrick Underwood, Alexandria (AU); Giulio Reina, Bari (IT)

(73) Assignee: THE UNIVERSITY OF SYDNEY, Sydney, New South Wales (AU)

(21) Appl. No.: 13/884,850

(22) PCT Filed: Nov. 10, 2011
(86) PCT No.: PCT/AU2011/001458

§ 371 Date: Jul. 2, 2013

(30) Foreign Application Priority Data
Nov. 11, 2010 (AU) 2010905003

(51) Int. Cl. G01S 13/42

(52) U.S. Cl. CPC G01S 13/42
USPC 342/146

(57) ABSTRACT

Apparatus and a method for processing a radar image, the method comprising: using a radar, generating a radar image of an area of terrain (8), the radar image deriving from radar observations taken along a plurality of azimuth angles; performing a background extraction process on the radar image to extract a background image comprising extracted radar observations, the background extraction process comprising estimating a range spread of a radar echo from the surface of the terrain (8) as function of the azimuth angle and a tilt of the radar relative to the surface of the terrain (8); fitting a model to the extracted radar observations along a particular azimuth angle; determining a value of a parameter indicative of the goodness of fit between the model and the extracted radar observations along the particular azimuth angle; and determining a classification depending on the value of the parameter for that azimuth angle.

### FIELD OF THE INVENTION

The present invention relates to the processing of radar images.

### BACKGROUND

Autonomous vehicles may be implemented in many outdoor applications such as mining, earth moving, agriculture, and planetary-exploration.

Imaging sensors mounted on the vehicles facilitate obstacle avoidance, task-specific target detection and generation of terrain maps for navigation.

Visibility conditions may be poor in the scenarios in which autonomous vehicles are implemented. For example, day/night cycles change illumination conditions, weather phenomena such as fog, rain, snow and hail, and the presence of dust or smoke clouds may impede visual perception.

Conventional imaging sensors, such as laser range-finders and cameras, tend to be adversely affected by these conditions.

Sonar is a common sensor typically not affected by such visibility restrictions. However, sonar suffers from a limited maximum range, poor angular resolution, and reflections by specular surfaces.

### SUMMARY OF THE INVENTION

In a first aspect, the present invention provides a method for performing radar image segmentation, the method comprising: using a radar, generating a radar image of an area of terrain, the radar image deriving from radar observations taken along a plurality of azimuth angles; performing a background extraction process on the radar image to extract a background image comprising extracted radar observations, the background extraction process comprising estimating a range spread of a radar echo from the surface of the terrain as function of the azimuth angle and a tilt of the radar relative to the surface of the terrain; fitting a model to the extracted radar observations along a particular azimuth angle; determining a value of a parameter indicative of the goodness of fit between the model and the extracted radar observations along the particular azimuth angle; and determining a classification depending on the value of the parameter for that azimuth angle.

The radar used to generate the radar image may be either directly in contact with the terrain, or mounted on a system or apparatus that is directly in contact with the terrain.

The radar observations may be taken in a near-field region of the radar.

The radar observations may be taken in a far-field region of the radar.

The steps of fitting a model, determining a value of a parameter, and determining a classification may be performed for each azimuth angle in the plurality of azimuth angles.

The estimate of the range spread of the radar echo from the surface of the terrain may be determined using the following equations:

$${R}_{0} = \frac{h}{cos θ sin α sin ϕ - sin θ cos α}$$

$${R}_{1} = \frac{h}{- cos θ cos ϕ sin \frac{{θ}_{e}}{2} + cos \frac{{θ}_{e}}{2} ( - cos α sin θ + cos θsin αsin ϕ )}$$

$${R}_{2} = \frac{h}{cos θ cos ϕ sin \frac{{θ}_{e}}{2} + cos \frac{{θ}_{e}}{2} ( - cos α sin θ + cos θ sin α sin ϕ )}$$

where:
R₀ is a value of slant range of a boresight of the radar;
R₁ is a range from the radar to a proximal border of a footprint area illuminated by the radar on the surface of the terrain during generation of the radar image;
R₂ is the range from the radar to a distal border of a footprint area illuminated by the radar on the surface of the terrain during generation of the radar image;
h is a height of an origin of the radar beam above the surface of the terrain;
φ and θ are the roll and pitch angles respectively of the radar relative to the surface of the terrain;
α is an azimuth angle; and
θₑ is a beamwidth of the radar.

The model may be a power return model.

The power return model may be:

$${P}_{r} ( R , {R}_{0} , k ) = k \frac{{G ( R , {R}_{0} )}^{2}}{cos β}$$

where:
R is a value of the range of a target on the terrain from the radar;
Pᵣ is a received power of the signal reflected from the target at distance R;
R₀ is the slant range of a boresight of the radar;
k is the power return at the slant range R₀;
G is a value of the gain of the radar; and
β is a grazing angle of the radar beam.

The parameter may be a coefficient of efficiency.

The step of classifying the background image may comprise: classifying data points along the particular azimuth angle in the background image as belonging to a first class if the value of the parameter for the particular azimuth angle is above a predetermined threshold value; and classifying data points along the particular azimuth angle in the background image as belonging to a second class if the value of the parameter for the particular azimuth angle is not above the predetermined threshold value.

The step of classifying the background image may further comprise: for an azimuth angle along which data points are classified as belonging to the first class, performing a physical consistency check using an output of the background extraction process for that azimuth angle, and classifying the data points along that azimuth angle as belonging to a third class depending on an output of the physical consistency check.

The step of classifying the background image may further comprise: for an azimuth angle along which data points are classified as belonging to the third class, determining a value of a further parameter; and identifying that an object is present along that azimuth angle if the value of the further parameter is above a further predetermined threshold.

The further parameter may be a percentage relative change of the maximum intensity value of the radar echo along the respective azimuth angle between an observation along that azimuth angle and the model.

In a further aspect, the present invention provides apparatus for processing a radar image, the apparatus comprising: a radar arranged to generate a radar image of an area of terrain, the radar image deriving from radar observations taken along a plurality of azimuth angles; and one or more processors arranged to: perform a background extraction process on the radar image to extract a background image comprising extracted radar observations, the background extraction process comprising estimating a range spread of a radar echo from the surface of the terrain as function of the azimuth angle and a tilt of the radar relative to the surface of the terrain; fit a model to the extracted radar observations along a particular azimuth angle; determine a value of a parameter indicative of the goodness of fit between the model and the extracted radar observations along the particular azimuth angle; and determine a classification depending on the value of the parameter for that azimuth angle.

In a further aspect, the present invention provides a program or plurality of programs arranged such that when executed by a computer system or one or more processors it/they cause the computer system or the one or more processors to operate in accordance with the method of any of the above aspects.

In a further aspect, the present invention provides a machine readable storage medium storing a program or at least one of the plurality of programs according to the above aspect.

### BRIEF DESCRIPTION OF THE DRAWINGS

FIG. 1 is a schematic illustration (not to scale) of a vehicle in which an embodiment of a process of generating a model of the ground in the vicinity of the vehicle is implemented;

FIG. 2 is a schematic illustration of an example terrain modelling scenario in which the vehicle is used to scan a terrain area;

FIG. 3 shows a so-called pencil radar beam hitting the surface of the terrain at a particular grazing angle;

FIG. 4 is a process flow-chart of an embodiment of a radar ground segmentation process;

FIG. 5 is a process flow-chart of a background extraction process performed at step s2 of the radar ground segmentation process; and

FIG. 6 is a process flow-chart of a process of power spectrum analysis performed at step s4 of the radar ground segmentation process.

### DETAILED DESCRIPTION

The terminology “ground” is used herein to refer to a geometric configuration of an underlying supporting surface of an environment or a region of an environment. The underlying supporting surface may, for example, include surfaces such as the underlying geological terrain in a rural setting, or the artificial support surface in an urban setting, either indoors or outdoors.

The terminology “ground based” is used herein to refer to a system that is either directly in contact with the ground, or that is mounted on a further system that is directly in contact with the ground.

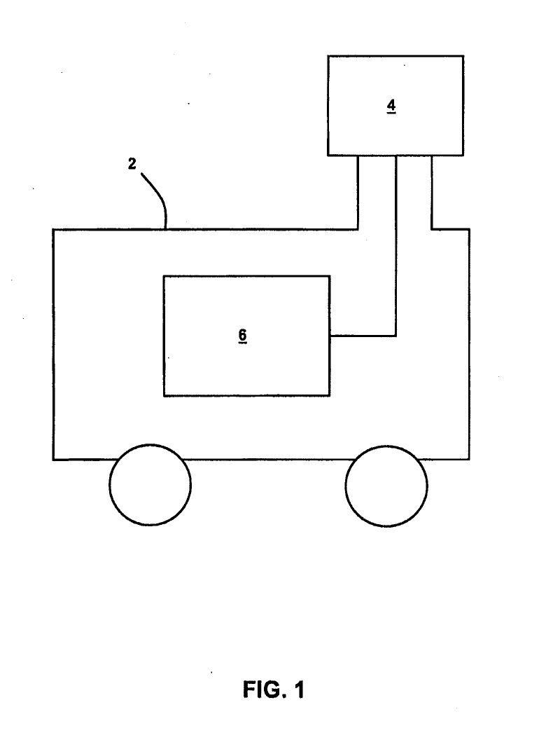

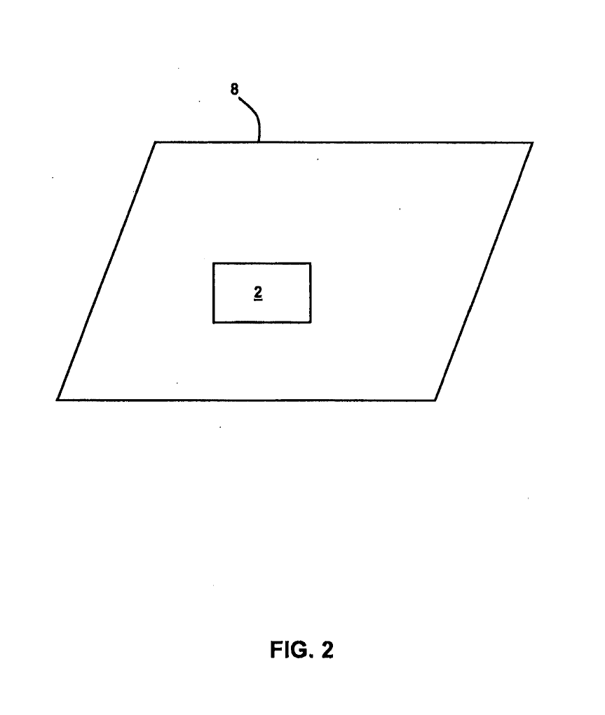

FIG. 1 is a schematic illustration (not to scale) of a vehicle 2 in which an embodiment of a process of generating a model of the ground in the vicinity of the vehicle 2 is implemented. This process will hereinafter be referred to as a “radar ground segmentation process”. FIG. 2 is a schematic illustration of an example terrain modelling scenario in which the vehicle 2 is used to scan a terrain area 8. In this scenario, the vehicle 2 uses the radar system 4 to scan the terrain area 8.

In this embodiment, the vehicle 2 comprises a radar system 4, and a processor 6.

In this embodiment, the vehicle 2 is an autonomous and unmanned ground-based vehicle. During operation, the ground-based vehicle 2 is in contact with a surface of the terrain area 8, i.e. the ground. Thus, in this embodiment, the radar system is a ground-based system (because it is mounted in the ground-based vehicle 2).

In this embodiment, the radar system 4 is coupled to the processor 6.

In this embodiment, the radar system 4 comprises a mechanically scanned millimetre-wave radar. The radar is a 95-GHz Frequency Modulated Continuous Wave (FMCW) millimetre-wave radar that reports the amplitude of echoes at ranges between 1 m and 120 m. The wavelength of the emitted radar signal is 3 mm. The beam-width of the emitted radar signal is 3.0° in elevation and 3.0° in azimuth. A radar antenna of the radar system 4 scans horizontally across the angular range of 360°.

In operation, the radar system 4 radiates a continuous wave (CW) signal towards a target through an antenna. An echo is received from the target by the antenna. A signal corresponding to the received echo is sent from the radar system 4 to the processor 6.

In this embodiment, the processor 6 comprises a spectrum analyzer to produce a range-amplitude profile that represents the target, i.e. a radar image.

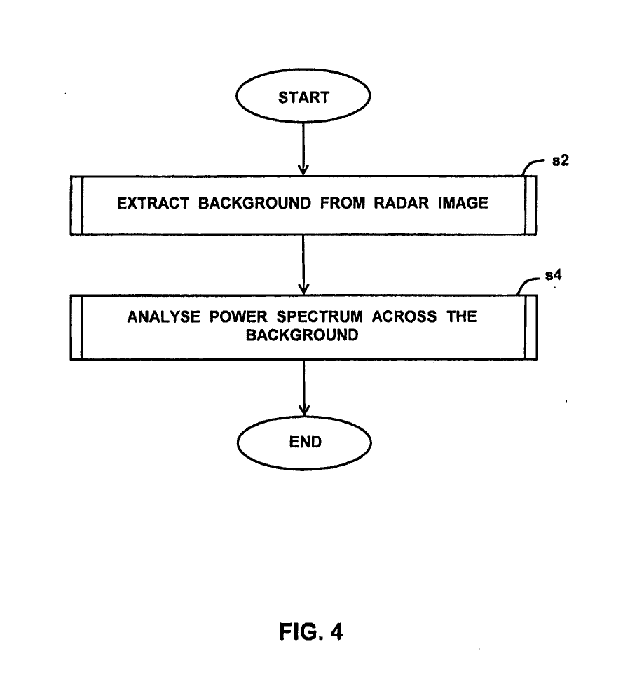

Also, in this embodiment, the processor 6 performs a radar ground segmentation process on the radar image, as described in more detail later below with reference to FIG. 4.

FIG. 2 is a schematic illustration of an example terrain modelling scenario in which the vehicle 2 is used to scan a terrain area 8. In this scenario, the vehicle 2 uses the radar system 4 to scan the terrain area 8.

The radar system 4 (i.e. the millimetre-wave radar) provides a so-called pencil beam with relatively small antenna apertures. A relatively accurate range map (i.e. radar image) of the terrain area 8 is constructed through the scanning of the terrain area with the pencil beam.

The beam width is proportional to the radar signal wavelength and is inversely proportional to the antenna aperture. Using a narrower beam tends to produce more accurate terrain maps and obstacle detection than using a wider beam. However, in this embodiment, radar antenna size is limited by vehicle size and spatial constraints.

Radars are typically used to sense targets in the so-called antenna far-field region. In this embodiment, the beginning of the far-field region for the radar antenna of the radar system 4 approximately begins at a distance of 15 m from the radar system 4. However, in this embodiment, short-range sensing by the vehicle 2 is implemented because many targets fall within the so-called near-field region (i.e. at a distance of less than approximately 15 m from the vehicle 2). In this near-field region the antenna pattern is range-dependent and the average energy density of the radar signal remains relatively constant at different distances from the antenna.

In other words, the radar system 4 is used to generate a radar image of the area of terrain 8 in the near-field region of the radar in the radar system 4. A radar operating partially, or wholly, in the near-field may be conveniently referred to as “short-range”. Also, the generated image may be conveniently referred to as a “short-range image”.

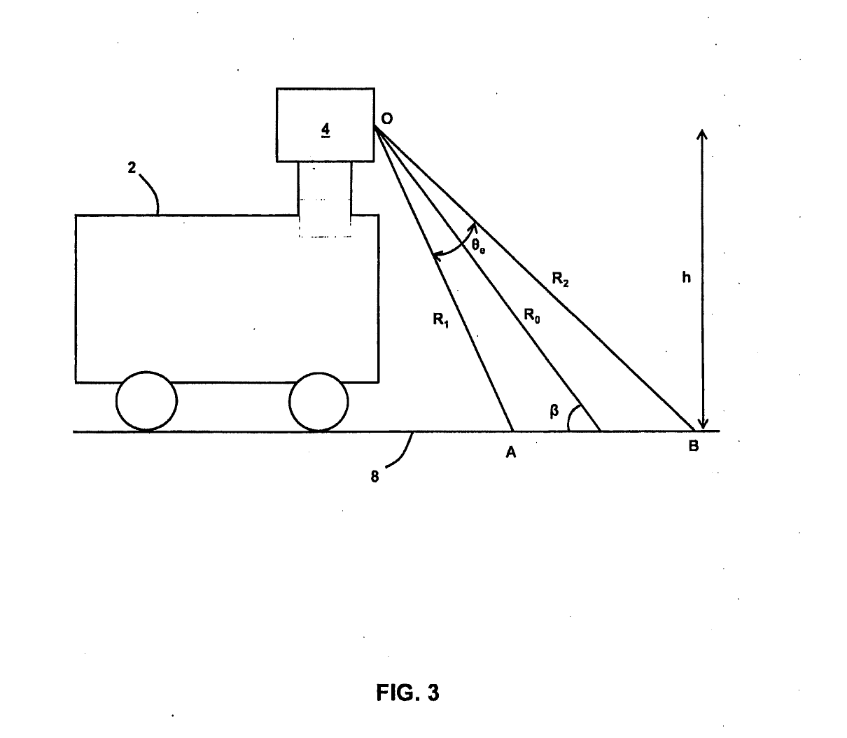

FIG. 3 is a schematic illustration of the beam geometries of the radar system 4 in this embodiment.

In this embodiment, the radar is directed at the front of the vehicle 2 with a constant pitch or grazing angle β of about 11 degrees. The scanning pencil beam intersects the ground at near-grazing angles.

FIG. 3 shows the pencil beam hitting the surface of the terrain 8 at a grazing angle β.

In FIG. 3, the origin of the beam is shown to be the front and centre of the radar system 4 and is indicated in FIG. 3 by the reference symbol O.

A beamwidth of the radar beam is indicated in FIG. 3 by the reference symbol θₑ.

A proximal border of a footprint area illuminated by the divergence beam is indicated in FIG. 3 with the reference symbol A.

A distal border of a footprint area illuminated by the divergence beam is indicated in FIG. 3 with the reference symbol B.

A height of the beam origin O with respect to the surface of the terrain 6 is indicated in FIG. 3 by the reference symbol h.

A slant range of the radar boresight is indicated in FIG. 3 by the reference symbol R₀.

A range from the radar to the proximal border A is indicated in FIG. 3 by the reference symbol R₁.

A range from the radar to the distal border B is indicated in FIG. 3 by the reference symbol R₂.

Short-range sensing in the near-field region tends to stretch the pencil-beam footprint resulting in range-echo spread. In principle, the computation of the area on the ground surface, which is instantaneously illuminated by the radar, depends on the geometry of the radar boresight, elevation beamwidth, resolution, and incidence angle to the local surface.

In this embodiment, when the radar echo data are received from the surface of the terrain 8 by the antenna, a signal corresponding to the received echo is sent from the radar system 4 to the processor 6. The processor 6 produces a radar image of the surface of the terrain 8 using the received signal. Also, the processor 6 performs a radar ground segmentation process on the radar image.

In this embodiment, the radar image is composed of a foreground and a background. The background of the radar image is the part of the image that results from reflections from the ground (i.e. terrain surface 8). The foreground of the radar image is the part of the image that results from reflection from objects, or terrain features, above the ground.

Radar observations belonging to the background tend to show a wide pulse produced by a high-incident angle surface. However, exceptions to this are possible, for example due to local unevenness or occlusion produced by obstacles of large cross-sections in the foreground.

FIG. 4 is a process flow-chart of an embodiment of a radar ground segmentation process.

At step s2, a background extraction process is performed on the radar image.

This process extracts the ground echo from the radar image.

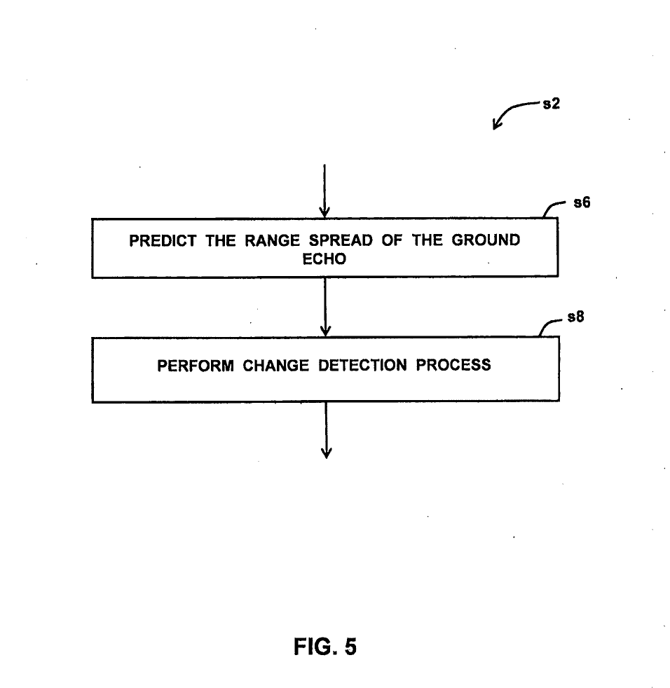

The background extraction process is described in more detail later below with reference to FIG. 5.

At step s4, the power spectrum across the background is analysed.

This process results in a segmented ground model of the terrain 8 in the vicinity of the vehicle 2.

In the remainder of this section, each stage is described in detail.

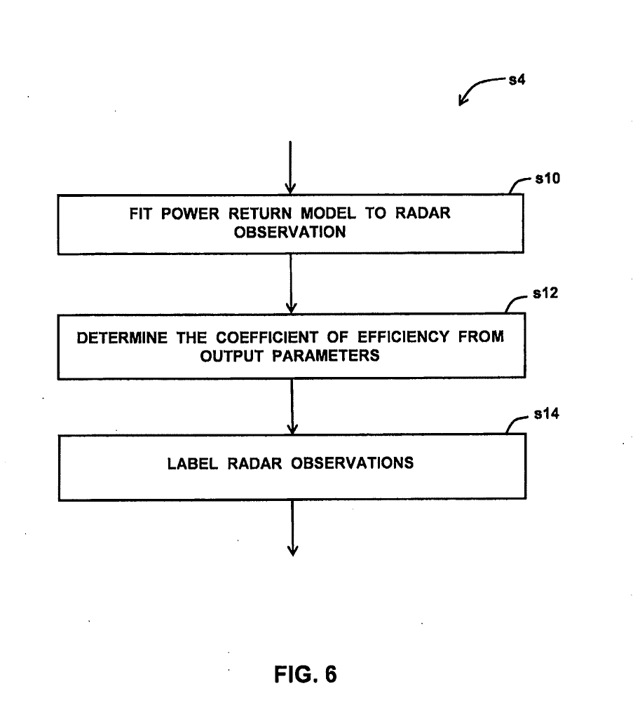

The background extraction process is described in more detail later below with reference to FIG. 6.

Thus, a radar ground segmentation process is provided.

FIG. 5 is a process flow-chart of a background extraction process performed at step s2 of the radar ground segmentation process of FIG. 4.

At step s6, a range spread of the ground echo is predicted.

In this embodiment, the prediction of the range spread of the ground echo as function of the azimuth angle and the tilt of the vehicle is obtained using the following geometrical model:

$${R}_{0} = \frac{h}{cos θ sin α sin ϕ - sin θcos α}$$

$${R}_{1} = \frac{h}{- cos θcos ϕ sin \frac{{θ}_{e}}{2} + cos \frac{{θ}_{e}}{2} ( - cos α sin θ + cos θsin α sin ϕ )}$$

$${R}_{2} = \frac{h}{cos θcos ϕ sin \frac{{θ}_{e}}{2} + cos \frac{{θ}_{e}}{2} ( - cos α sin θ + cos θsinα sin ϕ )}$$

where:
R₀ is the slant range of the radar boresight as shown in FIG. 3;
R₁ is the range to the proximal border A as shown in FIG. 3;
R₂ is the range to the distal border B as shown in FIG. 3;
h is the height of the radar beam origin O with respect to the surface of the terrain 8, as shown in FIG. 3;
φ and θ are the roll and pitch angles respectively of the radar system 4 on the vehicle 2. Together φ and θ described the tilt of the vehicle 2. φ and θ are conventional Euler angles (the ZYX Euler angles being φ, θ, and ψ, usually referred to as the roll, pitch, and taw angles respectively);
α is an azimuth angle measured by the radar system 4; and
θₑ is the beamwidth of the radar beam as shown in FIG. 3.

The above geometrical model is based on an assumption of globally flat ground. Therefore, discrepancies in radar observations may be produced by the presence of irregularities or obstacles in the radar-illuminated area. In this embodiment, these discrepancies are compensated for by the performance of step s8, as described in more detail below.

At step s8, a change detection algorithm is applied in the vicinity of the model prediction.

In this embodiment, a cumulative sum (CUSUM) test that is based on the cumulative sums charts to detect systematic changes over time in a measured stationary variable.

Further detail on the CUSUM process used in this embodiment can be found in “Continuous inspection schemes”, E. S. Page, Biometrika, 1954, Vol. 41, pp. 100-115, which is incorporated herein by reference.

The CUSUM test tends to be computationally simple, intuitively easy to understand and can be motivated to be fairly robust to different types of changes (abrupt or incipient).

In this embodiment, the CUSUM test looks at prediction errors εₜ of a power intensity value.

In this embodiment the data is normally distributed. Thus, the following relationship holds:

$${ɛ}_{t} = \frac{{x}_{t} - {\overline{x}}_{t}}{σ}$$

where:
xₜ is a power intensity of a particular point t in the radar image;
x̅ₜ is the mean of the power intensity of the observed radar data;
σ is the standard deviation of the power intensity; and
εₜ is a measure of the deviation of an observed power intensity value from a target value.

In this embodiment, the further the observation is away from the target, the larger εₜ is. In this embodiment, this test is implemented as a time recursion.

The CUSUM test gives an alarm when the recent prediction errors have been sufficiently positive for a certain amount of time. Also, in this embodiment, the CUSUM test provides an alarm only if the power intensity increases.

By applying the change detection algorithm in the vicinity of the model prediction, the ground echo is extracted from the radar image for a given azimuth angle. By repeating the process for all the azimuth angles, the background of the radar image is extracted from the radar image.

Thus, a background extraction process is provided.

FIG. 6 is a process flow-chart of a process of power spectrum analysis performed at step s4 of the radar ground segmentation process of FIG. 4.

At step s10, a power return model is fit to the radar observation for each azimuth angle.

The power return model used in this embodiment is as follows.

$${P}_{r} ( R , {R}_{0} , k ) = k \frac{{G ( R , {R}_{0} )}^{2}}{cos β}$$

where:
R is a distance of a target from the radar system 4;
Pᵣ is a received power of the signal reflected from the target at distance R;
R₀ is the slant range of the radar boresight as shown in FIG. 3;
k is a the power return at the slant range R₀;
G is the antenna gain; and
β is the grazing angle of the pencil beam hitting the surface of the terrain 8, as shown in FIG. 3.

In this embodiment, a good match between the parametric model of the power return and the data attests to a high likelihood of traversable ground. Conversely, a poor goodness of fit between the model and the data suggests a low likelihood (due, for example, to the presence of an obstacle or to irregular terrain).

In this embodiment, Pᵣ is a function of the parameters R₀ and k. The values of k can be interpreted as the power return corresponding to the range of the central beam R₀, and can be estimated by data fitting for each azimuth angle.

In this embodiment, the parameters are continuously updated across the image background. This advantageously tends to provide that the model can be adjusted to local ground roughness and tends to produce a more accurate estimation of R₀.

In this embodiment, a non-linear least squares approach using the Gauss-Newton-Marquardt method is adopted for data fitting. Further details on this process can be found in “Nonlinear Regression”, Seber, G. A. F., and C. J. Wild, John Wiley & Sons Inc., 1989, which is incorporated herein by reference.

In this embodiment, the initial parameter estimates (of R₀ and k) are chosen as the maximum measured power value and the predicted range of the central beam respectively. This advantageously tends to limit the problems of ill conditioning and divergence.

The output of the fitting process of step s10 is updated parameter values for R₀ and k. Also, an estimate of the goodness of fit of the model is output.

At step s12, a coefficient of efficiency is determined for each azimuth angle in the extracted image background using the output parameter values (R₀ and k) for that azimuth angle (that are determined at step s10 above).

In this embodiment, the coefficient of efficiency for a particular azimuth angle is determined using the following formula:

$$E = 1 - \frac{{\sum }_{i} {( {t}_{i} - {y}_{i} )}^{2}}{{\sum }_{i} {( {t}_{i} - \overline{t} )}^{2}}$$

where:
E is the coefficient of efficiency for the particular azimuth angle;
tᵢ is the measured intensity value of the ith data point along the particular azimuth angle;
t̅ is the mean of measured intensity value of the data points along the particular azimuth angle; and
y is the output from the fitting process of step s10 for the ith data point.

In this embodiment, E ranges from −∞ to 1. Also, E is equal to 0 when the square of the differences between measured and estimated values is as large as the variability in the measured data.

At steps s14, radar observations in every azimuth angle are labelled.

In this embodiment, the classification or labelling of the radar observations along an azimuth angle are performed as follows.

Firstly, the data points along a particular azimuth angle are labelled as “ground” if the determined coefficient of efficiency E for that azimuth angle is greater than or equal to an experimentally determined threshold T₁. In this embodiment, T₁ is equal to 0.8 (or 80%). However, in other embodiments, T₁ is equal to a different value. Also, in other embodiments, T₁ is determined by a different appropriate method, i.e. other than experimentally.

Also, the data points along a particular azimuth angle are labelled as “not ground” if the determined coefficient of efficiency E for that azimuth angle is less than T₁.

Secondly, for each data point along an azimuth angle labelled as “ground”, a physical consistency check is performed. In this embodiment, a physical consistency check is performed by comparing the updated values of the proximal, distal and central range (i.e. R₁, R₂ and R₀ respectively) to each other. If the difference between the proximal and central range, i.e. (R₁-R₀) is lower than a further experimentally determined threshold T₂, then the radar observation is more correctly labelled as “uncertain ground”. A similar check is performed between the central and distal range, i.e. (R₀-R₂).

In this embodiment, for each azimuth angle labelled as “uncertain ground” an additional, optional process is performed. In this embodiment, for each “uncertain ground” classification an additional check is performed to detect possible obstacles present a the region of interest. These obstacles may appear as narrow pulses of high intensity. In this embodiment, during operation, a value k̅ is recorded (this value defines a variation range for the ground return). A percentage relative change in the maximum intensity value between the observation tₘₐₓ, and the model yₘₐₓ is ΔP, where ΔP==tₘₐₓ−yₘₐₓ. In other words, ΔP is a percentage relative change of the maximum intensity value of the radar echo along the respective azimuth angle between an observation along that azimuth angle and the model. In this embodiment, when ΔP exceeds a predetermined threshold T₃, then it is determined that an object is present along that azimuth angle. In this embodiment, the value of the predetermined threshold T₃ is determined experimentally. This process advantageously tends to detect obstacles present along that azimuth angle which appear as narrow pulses of high intensity.

Thus, a method of analysing the power spectrum across the extracted image background is performed.

An optional additional process of assessing the accuracy of the system may be performed. The accuracy of the system in measuring the distance from the ground may be assessed through comparison with a “true ground map”. In this embodiment, for the ith ground-labelled observation, the above described system outputs a relative slant range R_{0,i}. Using the above described geometric relationships a corresponding 3-D point in a world reference frame Pᵢ is estimated. This is compared to a closest neighbour in the ground truth map Pᵢ^{gt}. In this embodiment, a mean square error in the elevation map is:

$${E}_{z} = \frac{1}{n} \sqrt{\sum {( {P}_{z , i} - {P}_{z , i}^{gt} )}^{2}}$$

Similarly, the accuracy of the system in measuring the position of detected obstacles can be evaluated by comparison with a “true obstacle map”. A mean square error for this application is:

$${MSE}_{xy} = \frac{1}{n} \sqrt{\sum {( {P}_{x , i} - {P}_{x , i}^{gt} )}^{2} + {( {P}_{y , i} - {P}_{y , i}^{gt} )}^{2}}$$

This completes this description of the ground segmentation process performed using radar.

An advantage provided by the above described radar ground segmentation process is that obstacle avoidance, task-specific target detection, and the generation of terrain maps for navigation tend to be facilitated. Moreover, other applications including scene understanding, segmentation classification, and dynamic tracking etc. tend to be advantageously facilitated.

Problems caused by poor visibility conditions, changing illumination conditions, weather phenomena such as fog, rain, snow and hail, dust clouds, smoke tend to be reduced or eliminated. Conventional sensors such as laser range finders, or visible-light cameras, tend to be affected by these conditions. The sizes of dust particles, fog droplets and snowflakes are comparable to the wavelength of visual light so clouds of particles block and disperse the laser beams impeding perception. Sonar is a common sensor not affected by visibility restrictions. However, sonar suffers from a limited maximum range, poor angular resolution, and reflections by specular surfaces. The use of millimetre-wave (MMW) radar tends to provide consistent range measurements for the environmental imaging needed to perform autonomous operations in dusty, foggy, blizzard-blinding and poorly lit environments. This is because the radar operates at a wavelength that penetrates dust and other visual obscurants.

A further advantage is that radar tends to provide information of distributed targets and of multiple targets that appear in a single observation.

A model describing the geometric and intensity properties of the ground echo in radar imagery is advantageously provided and exploited. This model advantageously facilitates the performance of the radar ground segmentation process, which tends to allow classification of observed ground returns.

The above described process advantageously tends to enhance vehicle perception capabilities, e.g. in natural terrain and in all conditions. The identification of the ground tends to be facilitated (the ground typically being the terrain that is most likely to be traversable). The provided method and system advantageously tends to allow the vehicle to identify a traversable patch of its nearby environment with a single sweep.

Moreover, the ground echo model tends to allow for range estimation along the entire ground footprint for accurate environment mapping.

A further advantage of the provided process is that the process tends to be relatively fast and reliable, and capable of extracting features from a large set of noisy data.

A further advantage of the provided process is that the radar antennas used in the process tend to be of a size that allows the radars to be mounted on a vehicle, e.g. an autonomous ground vehicle.

A further advantage provided by the above described process is that is that the accuracy of the measured ground surface tends to be improved to ‘sub pixel’ levels. This tends to yield improved accuracy other conventional methods, such as selecting the highest intensity peak as the ground point, which is subject to the range resolution of the radar.

Apparatus, including the processor 6, for implementing the above arrangement, and performing the method steps to be described above, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

It should be noted that certain of the process steps depicted in the flowcharts of FIGS. 4 to 6, and described above may be omitted or such process steps may be performed in differing order to that presented above and shown in the Figures. Furthermore, although all the process steps have, for convenience and ease of understanding, been depicted as discrete temporally-sequential steps, nevertheless some of the process steps may in fact be performed simultaneously or at least overlapping to some extent temporally.

In the above embodiments, the vehicle is an autonomous and unmanned land-based vehicle. However, in other embodiments the vehicle is a different type of vehicle. For example, in other embodiments the vehicle is a manned and/or semi-autonomous vehicle. Also, in other embodiments, the above described radar ground segmentation process is implemented on a different type of entity instead of or in addition to a vehicle. For example, in other embodiments the above described system/method may be implemented in an Unmanned Aerial Vehicle, or helicopter (e.g. to improve landing operations), or as a so-called “robotic cane” for visually impaired people. In another embodiment, the above described system/method is implemented in a stationary system for security application, e.g. a fixed area scanner for tracking people or other moving objects by separating them from the ground return.

In the above embodiments, the radar is a 95-GHz Frequency Modulated Continuous Wave (FMCW) millimetre-wave radar that reports the amplitude of echoes at ranges between 1 m and 120 m. The wavelength of the emitted radar signal is 3 mm. The beam-width of the emitted radar signal is 3.0° in elevation and 3.0° in azimuth. However, in other embodiments the radar is a different appropriate type of radar e.g. a radar having different appropriate specifications.

In the above embodiments, the vehicle is used to implement the radar ground segmentation process in the scenario described above with reference to FIG. 2. However, in other embodiments the above described process is implemented in a different appropriate scenario, for example, a scenario in which a variety of terrain features and or objects are present, and/or in the presence of challenging environmental conditions such as adverse weather conditions or dust/smoke clouds.

In the above embodiments, the beginning of the far-field region for the radar antenna is 15 m from the radar system. However, in other embodiments the far-field region begins at a different distance from the radar system.

In the above embodiments, the radar signal is directed at the front of the vehicle with a constant pitch or grazing angle β of about 11 degrees. However, in other embodiments the radar signal is directed from a different area of the vehicle at any appropriate grazing angle.

In the above embodiments, the geometrical model used at step s6 to estimate the range spread of the ground echo is based on an assumption of globally flat ground. However, in other embodiments this assumption is not made, or a different assumption is made.

In the above embodiments, the radar system is used to generate a radar image of the area of terrain in the near-field region of the radar in the radar system 4. The radar operates partially, or wholly, in the radar near-field. However, in other embodiments, the radar system may be used to generate images, i.e. operate, partially or wholly in the radar far-field.

In the above embodiments, at step s8, a change detection algorithm is implemented. In the above embodiments, a cumulative sum (CUSUM) test is used. However, in other embodiments a different appropriate change detection process is used, for example, using edge detection techniques to the whole radar image.

In the above embodiments, at step s10, a power return model is fit to the radar observation for each azimuth angle. The power return model used in the above embodiments is as described above with reference to step s10. However, in other embodiments a different type of model, or different power return model is fit to the radar observation.

In the above embodiments, a non-linear least squares approach using the Gauss-Newton-Marquardt method is adopted for data fitting. However, in other embodiments a different data fitting method is used.

In the above embodiments, at step s12, a coefficient of efficiency is determined for each azimuth angle in the extracted image background. However, in other embodiments a different type of confidence measure is determined for the extracted image background.

In the above embodiments, data points along each azimuth angle are classified as either “ground”, “not ground”, or “uncertain”. However, in other embodiments any number of different classifications may be used instead of or in addition to those classifications.

In the above embodiments, the data points along a particular azimuth angle are labelled as “ground” if the determined coefficient of efficiency E for that azimuth angle is greater than or equal to a threshold. However, in other embodiments a data point is classified as “ground” if one or more different criteria are satisfied instead of or in addition to the criterion that the coefficient of efficiency is greater than or equal to.

In the above embodiments, the data points along a particular azimuth angle are labelled as “not ground” if the determined coefficient of efficiency E for that azimuth angle is less than a threshold. However, in other embodiments a data point is classified as “not ground” if one or more different criteria are satisfied instead of or in addition to the criterion that the coefficient of efficiency is less than a threshold.

In the above embodiments, for each data point along an azimuth angle labelled as “ground”, a physical consistency check is performed. This may lead to a data point that has been classified as “ground” as being classified as “unknown”. However, in other embodiments a data point is classified as “unknown” if one or more different criteria are satisfied instead of or in addition to the criterion that consistency check is satisfied. Also, in other embodiments, a different type of consistency check is used.

In the above embodiments, for each azimuth angle labelled as “uncertain” a percentage relative change in the maximum intensity value between the observation and the model along the particular azimuth angle is determined. This value is then used to identify whether there is an obstacle in the region of interest. However, in other embodiments this process is not performed. Also, in other embodiments a different process is used to identify whether there is an object along a particular azimuth angle.

In the above embodiments, the radar system radiates a continuous wave (CW) signal towards a target through an antenna. However, in other embodiments, the radar signal has a different type of radar modulation.

1. A method for processing a radar image, the method comprising:
using a radar, generating a radar image of an area of terrain, the radar image deriving from radar observations taken along a plurality of azimuth angles;
performing a background extraction process on the radar image to extract a background image comprising extracted radar observations, the background extraction process comprising estimating a range spread of a radar echo from the surface of the terrain as function of the azimuth angle and a tilt of the radar relative to the surface of the terrain;
fitting a model to the extracted radar observations along a particular azimuth angle;
determining a value of a parameter indicative of the goodness of fit between the model and the extracted radar observations along the particular azimuth angle; and
determining a classification depending on the value of the parameter for that azimuth angle.

2. The method of claim 1, wherein the radar used to generate the radar image is either directly in contact with the terrain, or mounted on a system or apparatus that is directly in contact with the terrain.

3. The method of claim 1, wherein the radar observations are taken in a near-field region of the radar.

4. The method of claim 1, wherein the steps of fitting a model, determining a value of a parameter, and determining a classification are performed for each azimuth angle in the plurality of azimuth angles.

5. The method of claim 4, wherein the estimate of the range spread of the radar echo from the surface of the terrain is determined using the following equations:
$${R}_{0} = \frac{h}{cos θ sin α sin ϕ - sin θcos α}$$
$${R}_{1} = \frac{h}{- cos θcos ϕ sin \frac{{θ}_{e}}{2} + cos \frac{{θ}_{e}}{2} ( - cos α sin θ + cos θsin α sin ϕ )}$$
$${R}_{2} = \frac{h}{cos θcos ϕ sin \frac{{θ}_{e}}{2} + cos \frac{{θ}_{e}}{2} ( - cos α sin θ + cos θsinα sin ϕ )}$$
where:
R₀ is a value of slant range of a boresight of the radar;
R₁ is a range from the radar to a proximal border of a footprint area illuminated by the radar on the surface of the terrain during generation of the radar image;
R₂ is the range from the radar to a distal border of a footprint area illuminated by the radar on the surface of the terrain during generation of the radar image;
h is a height of an origin of the radar beam above the surface of the terrain;
φ and θ are the roll and pitch angles respectively of the radar relative to the surface of the terrain;
α is an azimuth angle; and
θₑ is a beamwidth of the radar.

6. A method according to claim 1, wherein the model is a power return model.

7. A method according to claim 5, wherein the power return model is:
$${P}_{r} ( R , {R}_{0} , k ) = k \frac{{G ( R , {R}_{0} )}^{2}}{cos β}$$
where:
R is a value of the range of a target on the terrain from the radar;
Pᵣ is a received power of the signal reflected from the target at distance R;
R₀ is the slant range of a boresight of the radar;
k is the power return at the slant range R₀;
G is a value of the gain of the radar; and
β is a grazing angle of the radar beam.

8. A method according to claim 1, wherein the parameter is a coefficient of efficiency.

9. A method according to claim 1, wherein the step of classifying the background image comprises:
classifying data points along the particular azimuth angle in the background image as belonging to a first class if the value of the parameter for the particular azimuth angle is above a predetermined threshold value; and
classifying data points along the particular azimuth angle in the background image as belonging to a second class if the value of the parameter for the particular azimuth angle is not above the predetermined threshold value.

10. A method according to claim 9, wherein the step of classifying the background image further comprises:
for an azimuth angle along which data points are classified as belonging to the first class, performing a physical consistency check using an output of the background extraction process for that azimuth angle, and classifying the data points along that azimuth angle as belonging to a third class depending on an output of the physical consistency check.

11. A method according to claim 10, wherein the step of classifying the background image further comprises:
for an azimuth angle along which data points are classified as belonging to the third class, determining a value of a further parameter; and
identifying that an object is present along that azimuth angle if the value of the further parameter is above a further predetermined threshold.

12. A method according to claim 11, wherein the further parameter is a percentage relative change of the maximum intensity value of the radar echo along the respective azimuth angle between an observation along that azimuth angle and the model.

13. Apparatus for processing a radar image, the apparatus comprising:
a radar arranged to generate a radar image of an area of terrain, the radar image deriving from radar observations taken along a plurality of azimuth angles; and
one or more processors arranged to:
perform a background extraction process on the radar image to extract a background image comprising extracted radar observations, the background extraction process comprising estimating a range spread of a radar echo from the surface of the terrain as function of the azimuth angle and a tilt of the radar relative to the surface of the terrain;
fit a model to the extracted radar observations along a particular azimuth angle;
determine a value of a parameter indicative of the goodness of fit between the model and the extracted radar observations along the particular azimuth angle; and
determine a classification depending on the value of the parameter for that azimuth angle.

14. A program or plurality of programs arranged such that when executed by a computer system or one or more processors it/they cause the computer system or the one or more processors to operate in accordance with the method of claim 1.

15. A machine readable storage medium storing a program or at least one of the plurality of programs according to claim 14.
